(19) United States
(12) Patent Application Publication
(10) Pub. No.: US 2009/0187205 A1
(43) Pub. Date: Jul. 23, 2009

(54) Acupuncture needle and an acupuncture needle guide assembly

(76) Inventor: Jiangang Shi, Wujiang (CN)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/151,676

(22) Filed: May 7, 2008

(30) Foreign Application Priority Data
Jan. 22, 2008 (CN) CN200820031395.1

(51) Int. Cl. A61H 39/08

(52) U.S. Cl. 606/189

(57) ABSTRACT

An acupuncture needle guide assembly includes an acupuncture needle with a needle handle and a needle body, a guiding tube accommodating the acupuncture needle, and a container formed of a bottom piece and a top cover piece fitting over the bottom piece to form a reservoir to store the acupuncture needle and provide a sterile protection before use. The acupuncture and guiding tube are mounted in the reservoir. Said needle handle has at least one wide part which is wider in cross-section than the other parts, being located outside said guiding tube and said reservoir has at least one narrow portion which is thinner in cross-section than other parts of the reservoir and also thinner than said wide part. In virtue of the wide part of the needle handle with the narrow part of the reservoir on the container, when the acupuncture needle is placed in the reservoir, its narrow part confines the location of the wide part of the needle handle and thus prevents the movement of the acupuncture needle relative to the container during transportation.

### FIELD OF THE INVENTION

The invention relates generally to acupuncture devices, and more particularly to an acupuncture needle and an acupuncture needle guide assembly including a guiding tube and a container to store an acupuncture needle and provide a sterile protection before use.

### BACKGROUND OF THE INVENTION

### Description of the Prior Art

Acupuncture is a traditional Chinese medical treatment which has gained increasing acceptance nowadays. In the related practice area of acupuncture, it has become more and more desirable to use disposable needles which are sterilized before packaging, so many kinds of storage containers for acupuncture needles, needle guide assemblies and the likes have been developed till today.

In the prior art, the most used packing method comprises two successive steps: first the sterilized acupuncture needle being mounted within a guide tube, and then they are arranged in a film-like dispensing bag to form an assembly. The film-like dispensing bag as a container and the guide tube provide a sterile protection of the needle before use as well as guidance for setting and inserting the acupuncture needle into a human's skin. The packing method has many disadvantages, including not only the inconvenience for discharging the acupuncture needle, but also the instability of the acupuncture needle and the guide tube in the dispensing container. As the acupuncture needle is not fixed to the container and the needle body of the acupuncture needle has an extremely small diameter, it shakes and jumps a lot during transportation to make the needle body liable to be abrased, and also the film-like container is liable to be punctured, such as by the needle tip.

To overcome above-mentioned disadvantages, Chinese Patent No. 932463525 discloses an acupuncture needle container, having a block fixed within, and the block is provided with many small holes matching with the acupuncture needles to make the needles mechanically stable. However, it is very inconvenient, time-consuming and expensive to package while place the needles into holes accurately one-to-one.

Another type of acupuncture needle container is disclosed in Chinese Pat. 022188053, which has a soft block fixed within so as to avoid the packing trouble as above-mentioned that acupuncture needles must be placed into the holes one-to-one. When packaging the acupuncture needle, puncturing needles into the soft block can make the needles be fixed. It is very easy and efficient to fix the acupuncture needle and thus increases the packaging efficiency, however, such a structure is still complicated and high-cost, especially brings some environmental pollution when the soft block is thrown away after the acupuncture needles being used.

### SUMMARY OF THE PRESENT INVENTION

Accordingly, the present invention overcomes these disadvantages of related art, such as listed herein, by providing an acupuncture needle with a storage container, in which the needle may not move relative to the container during transportation, and also the needle may be readily removable from the storage container.

Another object of the present invention is to provide an acupuncture needle guide assembly employing the storage container as above-mentioned.

In accordance with the purpose of the present invention, as embodied and broadly described herein, an acupuncture needle comprises a needle body having a tip and a needle handle having a larger outer diameter or cross section than the tip and having at least one wide part which is wider in cross-section than other parts of the needle handle.

Preferably, said wide part is located at the end of said handle portion opposite to the tip of said needle part.

In addition, the external wall of said handle presents to be spiral-shaped, for such a structure can make the practitioner more comfortable when handling and using the needle.

The present invention also provides an acupuncture needle guide assembly accommodating the acupuncture needle as above-described, comprising a container having a top cover piece, a bottom piece, said top cover piece fitting over the bottom piece to form a reservoir; and a guiding tube accommodating the acupuncture needle and providing guidance for inserting the acupuncture needle into human's skin. Said guiding tube is mounted (e.g., removably placed) in the reservoir of the container. Said acupuncture needle comprises a needle body having a tip and a needle handle having at least one wide part wider in cross-section than other parts of the needle handle. Said wide part is located outside said guiding tube, and there is at least one narrow part of the reservoir that is thinner in cross-section than other parts and also thinner in cross-section than said wide part.

Preferably, said wide part is located at the end opposite to the tip of said needle part.

An improvement of further stabilization of the acupuncture needle has been obtained in virtue of the wide part of the needle handle with the narrow part of the reservoir on the container. When the acupuncture needle is placed in the reservoir, its narrow part confines the location of the wide part of the needle handle longitudinally (e.g., along the axis of the needle) and thus prevents the movement of the needle longitudinally relative to the container during transportation. Such a structure can avoid the container being broken (e.g., by the needle tip) and is very simple and economical to produce.

### BRIEF DESCRIPTION OF THE DRAWINGS

A further understanding of the invention will become apparent and more readily appreciated from the following description of the embodiments, taken in conjunction with the accompanying drawings of which:

FIG. 1 is the perspective view of an acupuncture needle according to the present invention;

FIG. 2 is structure scheme of needle guide assembly according to the present invention.

### DETAILED DESCRIPTION OF PREFERRED EMBODIMENTS

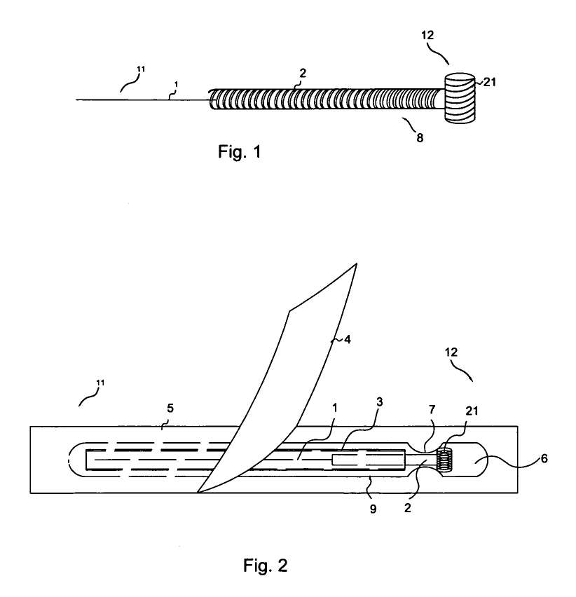

As shown in FIG. 1, an acupuncture needle 8 according to an embodiment of the present invention comprises a needle body (also identified as feature 8 in some descriptions) having a tip 1 in a proximal end 11 and a needle handle 2 annexed to (e.g., coupled or attached to) needle body 1 in a distal end 12 opposite to said tip. The needle handle 2 has a wide part 21, which is wider in cross-section than other parts of the needle handle 2 and than tip 1.

According to a preferable embodiment, the wide part 21 may be located at an end of the needle handle 2 near the distal end of the needle body 1 and opposite to the proximal end. In some embodiments, wide part 21 may have a longitudinal cross sectional shape (e.g., along the axis of the needle) that may be a rectangular, cylindrical or square shape. In some embodiments, wide part 21 may have cross sectional shape perpendicular or tangential to the longitudinal axis of the needle that may have a cylindrical shape. According to embodiments, wide part 21 will have a larger longitudinal cross sectional shape or maximum outer diameter than the other parts of the handle 2 and than tip 1.

Also, the external wall of said handle portion 2 may be designed in a spiral structure (e.g., having a spiral wound wire shape) or in a generally cylindrical shape so as to make the practitioner more comfortable when grasping or handling the handle.

As shown in FIG. 2, an acupuncture needle guide assembly comprises of a container and a needle pack 9. The container has a top cover piece 4 and a bottom piece 5, said top cover piece 4 fitting over the bottom piece 5 to form a reservoir 6. The reservoir 6 is formed on or in the bottom piece 5. The needle pack 9 which may be mounted and sealed within the reservoir 6 may comprise of an acupuncture needle 8 as shown in FIG. 1 and a guiding tube 3 outside the acupuncture needle 8, the guiding tube 3 accommodating the acupuncture needle 8, and also leaving the wide part 21 outside the tube 3.

The reservoir 6 has a narrow portion 7 which is thinnest in width of the reservoir and also thinner in cross-section than the wide part 21. The narrow portion 7 should be formed in a quite small width to make the part of the needle handle 2 which locates in the narrow portion 7 clapped or restrained by the internal sidewall of the narrow portion 7. In some embodiments, narrow portion 7 also can be a little wider than needle handle 2. According to embodiments, the width of the narrow portion 7 is thinner than the width of the wide part 21, so that after the acupuncture needle 8 placed into reservoir 6, the narrow portion 7 would limit or restrain movement of the wide part 21 (e.g., prohibit part 21 from moving longitudinally proximal to or past portion 7) and thus prevent the random movement of the needle body 8 or tip 1 fixed to the needle handle relatively to the container during transportation. In some embodiments, also due to the wide part 21, the needle body 8 or tip 1 can not slide along longitudinally (e.g., due to the narrow portion 7 restraining part 21), and thus can not puncture the bottom piece 5 or the top cover piece 4, such as with tip 1. In some embodiments, the narrow portion 7 also limits or restrains movement of the tube 3 (e.g., prohibit tube 3 from moving longitudinally distal to or past portion 7) thus prevent the random movement of the tube and/or needle body 8 or tip 1 within tube 3 relatively to the container during transportation.

Preferably, as shown in FIG. 2, the narrow portion 7 is formed near distal end 12 of said reservoir 6, and the wide part 21 is positioned between the end 12 and the narrow portion 7 of the reservoir 6. In some embodiments, the rest of the needle handle 2 (e.g., other than part 21) passes through the narrow portion 7 and/or is located in the reservoir 6 proximal to portion 7. According to embodiments, the arrangement described allows a handler or user to easily take out the acupuncture needle 8 from the reservoir 6 at the area where the wide part 21 is located, such as by grasping part 21 distal to portion 7. Moreover, the recess or width of the reservoir 6 distal to portion 7 can be set in or have a little larger width, so as to make it much easier for a user to take out the acupuncture needle 8, such as by grasping part 21 within reservoir 6 distal to portion 7.

In practical production, the bottom piece 5 may be generally made of plastic flake, the reservoir 6 may be shaped by plastic suction on the plastic flake, and the top cover piece 4 may be made of grade paper. After the needle pack 9 is placed into said reservoir 6, affixing the cover piece 4 onto the bottom piece 5 can make a sealed needle guide assembly. To use the acupuncture needle 8, a practitioner or user can take out the needle pack 9, by tearing only the top cover piece 4 away from piece 5.

For acupuncture treatment, an acupuncture needle may be first set into the skin of a patient at an acupuncture point using the guiding tube 3 to press the region of skin of the acupuncture point where the acupuncture needle 8 will be guided, which may distract the patient's attention and also reduce the patient's ache or pain feeling when the needle is inserted. The practitioner or user may then insert the acupuncture needle through the skin into the body. So the guiding tube 3 can not only help to puncture more accurately but also ease the pain of a patient.

1. An acupuncture needle comprising:
a needle body having a tip (1) at a proximal end; and
a needle handle (2) attached to said needle body at a distal end opposite to said proximal end;
wherein said needle handle (2) comprising at least one wide part (21) which is wider in cross-section than other parts of the needle handle (2).

2. The acupuncture needle according to claim 1, wherein said wide part (21) is located at the end of said needle handle (2) opposite to said tip of the needle body (1).

3. The acupuncture needle according to claim 1, wherein the external wall of said needle handle (2) is shaped in a spiral structure.

4. An acupuncture needle guide assembly comprising:
a container comprising a bottom piece (5) and a top cover piece (4) fitting over the bottom piece (5) to form a reservoir (6) between the bottom piece (5) and the top cover piece (4); and
a needle pack (9) comprising an acupuncture needle (8) and a guiding tube (3) to accommodate said acupuncture needle (8);
said acupuncture needle (8) comprising: a needle body (1) having a tip at a proximal end; a needle handle (2) attached to said needle body (1) at a distal end opposite to said tip;
said needle pack (9) being mounted within the said reservoir (6);
wherein said needle handle (2) comprises at least one wide part (21) which is wider in cross-section than other parts of the needle handle, said wide part (21) being outside said guiding tube (3); and
said reservoir (6) has at least one narrow portion (7) which is thinner in cross-section than other parts of the reservoir and also thinner than said wide part (21).

5. The acupuncture needle guide assembly according to claim 4, wherein said wide part (21) is located at the end of said needle handle (2) opposite to said needle tip.
